(19) United States
(12) Patent Application Publication
(10) Pub. No.: US 2025/0178238 A1
(43) Pub. Date: Jun. 5, 2025

(54) METHOD AND RECYCLING PLANT FOR RECYCLING PLASTIC WASTE MATERIAL

(71) Applicant: Coperion GmbH, Stuttgart (DE)

(72) Inventor: Jörg METZGER, Bous (DE)

(73) Assignee: Coperion GmbH, Stuttgart (DE)

(21) Appl. No.: 18/836,672

(22) PCT Filed: Jan. 23, 2023
(86) PCT No.: PCT/EP2023/051491

§ 371 Date: Aug. 7, 2024

(30) Foreign Application Priority Data
Feb. 10, 2022 (DE) 10 2022 201 398.0

(51) Int. Cl. B29B 7/46; B29B 7/00; B29B 7/72; B29B 7/84; B29B 7/88; B29B 17/00; B29B 17/02; B29K 23/00; B29K 105/00; C08J 3/00

(52) U.S. Cl. CPC B29B 7/46; B29B 7/007; B29B 7/726; B29B 7/88; B29B 17/00; C08J 3/005; B29B 7/84; B29B 2017/0224; B29K 2023/00; B29K 2105/0094; C08J 2323/00

(57) ABSTRACT

In a method for recycling plastic waste material, plastic waste material is supplied to a first screw machine and melted therein to form a plastic waste material melt. The plastic waste material melt is supplied to a second multi-shaft screw machine by means of a supply device and is processed therein together with plastic raw material to form a plastic material melt.

### CROSS-REFERENCES TO RELATED APPLICATIONS

This application is a U.S. National Stage Application under 35 U.S.C. § 371 of International Patent Application No. PCT/EP 2023/051491, filed Jan. 23, 2023, which claims the priority of German patent application, Serial No. DE 10 2022 201 398.0, filed Feb. 10, 2022, the content of which is incorporated herein by reference in their entirety as if fully set forth herein.

### TECHNICAL FIELD

The disclosure relates to a method and a recycling plant for recycling plastic waste material, in particular polyolefin waste material.

### BACKGROUND

DE 10 2019 127 827 A1 discloses a method for producing plastic products from a recycled plastic material and an unrecycled virgin plastic material. The products are manufactured using an extrusion plant. The base material of the plastic products is a polymeric raw material, such as polyolefins. To manufacture the plastic products, a granulate of the recycled plastic material and a granulate of the unrecycled virgin plastic material are supplied to the extrusion plant in certain proportions. The extrusion plant produces new compounds or films as plastic products from the granulates supplied, for example.

### SUMMARY

It is an object of the disclosure to create a method which enables simple, flexible, qualitatively reliable and energy-efficient recycling of plastic waste material, in particular polyolefin waste material.

This object is achieved by a method for recycling plastic waste material, in particular polyolefin waste material, comprising the following step:
providing a first screw machine, in particular a first multi-shaft screw machine, and a second multi-shaft screw machine,
supplying plastic waste material into the first screw machine and melting of the plastic waste material by means of the first screw machine to form a plastic waste material melt,
supplying plastic raw material into the second multi-shaft screw machine and processing of the plastic raw material by means of the second multi-shaft screw machine to form a plastic raw material melt,
supplying the plastic waste material melt into the second multi-shaft screw machine, and
mixing the plastic raw material melt and the plastic waste material melt by means of the second multi-shaft screw machine to form a plastic material melt.

The plastic waste material to be processed, in particular the polyolefin waste material to be processed, is first supplied to the first screw machine, in particular the first multi-shaft screw machine, and melted into a plastic waste material melt by means of the first screw machine. The plastic waste material is made from plastic products that have been shredded and/or cleaned or washed. The plastic waste material is present in particular as bulk material, for example as flakes and/or pellets. In particular, the plastic waste material has not already been processed by means of a screw machine prior to being supplied to the first screw machine. In particular, the plastic waste material is not a plastic waste material granulate that has been produced by processing and granulating plastic waste material.

In one example, a dwell time of the plastic waste material melt in the first screw machine can be adjusted by means of a throttling device. In particular, the throttling device is arranged downstream of the first screw machine. The throttling device comprises at least one throttling element for adjusting a flow resistance of the plastic waste material melt. The position of the at least one throttling element can be adjusted or changed for this purpose. A higher flow resistance leads to a longer dwell time and vice versa. By increasing the dwell time, the plastic waste material melt in the first screw machine is mixed and homogenized longer and thus more intensively, which has a positive effect on the quality of the plastic waste material melt.

Parallel to the melting of the plastic waste material, plastic raw material is supplied to the second multi-shaft screw machine, which is processed into a plastic raw material melt by means of the second multi-shaft screw machine. The plastic raw material can be supplied to the second multi-shaft screw machine as bulk material, for example as powder and/or granulate, or already as a melt. If the plastic raw material is supplied as bulk material, the processing involves melting the plastic raw material. If, on the other hand, the plastic raw material is already being supplied as a melt, processing involves conveying and the associated mixing of the plastic raw material melt. At least one additive can additionally be supplied to the second multi-shaft screw machine.

The plastic waste material melt is also supplied to the second multi-shaft screw machine. In one example, the plastic waste material is supplied to the second multi-shaft screw machine in a conveying direction downstream of the supply of the plastic raw material. In particular, the plastic waste material melt is supplied into the plastic raw material melt. The plastic raw material melt and the plastic waste material melt are then mixed or homogenized by means of the second multi-shaft screw machine to form a plastic material melt. The plastic material melt is then discharged from the second multi-shaft screw machine. The discharged plastic material melt is either processed directly into a plastic product or supplied to a pelletizing device, which produces plastic pellets or polyolefin pellets from the plastic material melt.

The method is simple and energy-efficient due to the fact that the plastic waste material is melted by means of the first screw machine and the plastic waste material melt is then supplied to the second multi-shaft screw machine—without the intermediate pelletizing step—and processed by mixing with the plastic raw material melt by means of the second multi-shaft screw machine. Due to the fact that the proportions of the plastic waste material and the plastic raw material can be flexibly adjusted depending on the initial quality of the plastic waste material means that the quality of the plastic material melt can be reliably guaranteed.

A method in which the plastic waste material melt is filtered by means of a filter device before being supplied into the second multi-shaft screw machine, ensures simple, flexible, qualitatively reliable and energy-efficient recycling. Due to the fact that the plastic waste material melt is filtered by means of a filter device before being supplied into the second multi-shaft screw machine, contaminants and/or agglomerates are not mixed with the plastic raw material melt. This increases the quality of the plastic material melt. The filter device may comprise at least two filter elements. Alternatively, the filter device comprises at least one filter element with a continuous cleaning and/or with a backwash function. This allows at least one filter element to be cleaned and/or replaced during operation. In one example, the filter device is designed as a screen changing device.

A method in which at least one parameter of the plastic waste material melt is determined by means of at least one sensor, ensures simple, flexible, qualitatively reliable and energy-efficient recycling. In one example, the determined at least one parameter characterizes at least one quality feature of the plastic waste material melt. This makes it possible to determine a quality measure for the plastic waste material melt. In particular, the determined at least one parameter is transmitted to a control device. In particular, a pressure, a temperature and/or a viscosity of the plastic waste material melt is determined by means of the at least one sensor. In one example, a pressure, a temperature and/or a viscosity of the plastic waste material melt is measured by means of at least one sensor immediately downstream of the first screw machine and/or immediately upstream of the filter device and/or downstream of the filter device. The measurement immediately downstream of the first screw machine provides information regarding the flow properties of the uncleaned plastic waste material melt. The measurement immediately upstream of the filter device provides information on the pressure increase as a function of time and/or on the degree of contamination of the plastic waste material melt as a function of a filtration fineness of the filter device. The filtration fineness of the at least one filter element is selected in dependence on the required quality of the plastic material melt. The measurement downstream of the filter device, in particular the viscosity measurement or the online viscosity measurement, provides information about the flow properties of the filtered plastic waste material melt and the expected viscosity of the plastic material melt. In particular, the viscosity can be adjusted by setting the dwell time of the plastic waste material melt in the first screw machine and/or by adding plastic raw material to the first screw machine.

A method in which a quality measure for the plastic waste material melt is determined by means of a control device in dependence on the determined at least one parameter of the plastic waste material melt, ensures simple, flexible, qualitatively reliable and energy-efficient recycling. Based on the quality measure, the quality of the plastic waste material melt can be assessed and/or the plastic waste material melt can be classified into different quality classes. This makes it possible to control the recycling in dependence on the quality measure or the quality classes. In particular, an inadequate quality of the plastic waste material melt can be reacted to immediately, for example by actuating a supplying device and/or a throttling device. In the simplest case, the quality measure is the at least one parameter. The measured values of the at least one parameter can be processed with regard to signalling by means of the control device. The quality measure is, for example, the measured viscosity of the plastic waste material melt downstream of a filter device.

A method in which at least one supplying device and/or a throttling device is actuated in dependence on the at least one parameter and/or the determined quality measure, ensures simple, flexible, qualitatively reliable and energy-efficient recycling. Due to the fact that at least one supplying device and/or a throttling device is actuated in dependence on the determined at least one parameter or the determined quality measure, an immediate reaction to an inadequate quality or an inadequate quality measure of the plastic waste material melt can be provided. The at least one supplying device prevents, for example, the supply of the plastic waste material melt into the second multi-shaft screw machine if the determined quality measure is outside a predefined range. Further, the at least one supplying device supplies, for example, plastic raw material and/or at least one additive into the first screw machine in order to increase the quality measure. The throttling device increases, for example, the flow resistance of the plastic waste material melt, so that the dwell time of the plastic waste material melt in the first screw machine is increased, which leads to longer and more intensive mixing or homogenization and thus to an increase in quality.

A method in which, in dependence on the at least one parameter and/or the determined quality measure, a supplying device for supplying the plastic waste material melt is actuated in such a manner that
the plastic waste material melt is supplied to the second multi-shaft screw machine if the at least one parameter and/or the determined quality measure is within a predefined range, and
the plastic waste material melt is not supplied to the second multi-shaft screw machine if the at least one parameter and/or the determined quality measure is outside the predefined range,
   ensures simple, flexible, qualitatively reliable and energy-efficient recycling. The plastic waste material melt is supplied to the second multi-shaft screw machine by means of a supplying device. The supplying device for supplying the plastic waste material melt comprises, in particular, at least one switching element that can be switched between a first switching position and a second switching position. Switching is controlled in particular by means of a control device. In one example, the supplying device comprises a drive for actuating the switching element.

In the first switching position, the plastic waste material melt is supplied to the second multi-shaft screw machine. The first switching position is set when the determined quality measure is within a predefined range. In the second switching position, the plastic waste material melt is not supplied to the second multi-shaft screw machine. The second switching position is set when the determined quality measure is outside the predefined range. In the second switching position, the plastic waste material melt can, for example, be supplied to a pelletizing device which pelletizes the plastic waste material melt into pellets. The pellets are of a comparatively low quality, but can still be processed further. Due to the fact that the supplying device for supplying the plastic waste material melt is actuated in dependence on the determined quality measure, the plastic waste material melt is only supplied to the second multi-shaft screw machine if it is of sufficient quality.

A method in which, in dependence on the at least one parameter and/or the determined quality measure, a supplying device for supplying plastic raw material and/or for supplying at least one additive is actuated in such a manner that plastic raw material and/or at least one additive is supplied to the first screw machine if the at least one parameter and/or the determined quality measure is outside a predefined range, ensures simple, flexible, qualitatively reliable and energy-efficient recycling. In order to increase the quality of the plastic waste material melt, plastic raw material and/or at least one additive can be supplied to the first screw machine by means of a supplying device. By supplying raw plastic material and/or at least one additive, the quality of the plastic waste material melt is increased, so that the determined quality measure is improved.

If the quality measure returns to the predefined range, the plastic waste material melt can be fed back to the second multi-shaft screw machine in particular by switching over a switching element.

A method in which the plastic waste material has a proportion m_{W} of the plastic material melt, wherein: 5 wt. %≤m_{W}≤50 wt. %, in particular 10 wt. %≤m_{W}≤45 wt. %, in particular 15 wt. %≤m_{W}≤40 wt. %, and in particular 20 wt. %≤m_{W}≤35 wt. %, ensures simple, flexible, qualitatively reliable and energy-efficient recycling. Due to the fact that the plastic waste material melt is of high quality and/or the quality of the plastic waste material melt is monitored, a high proportion m_{W} of plastic waste material can be recycled. In particular, the proportion m_{W} defines an average weight proportion in relation to the plastic material melt discharged from the second multi-shaft screw machine.

It is another object of the disclosure to provide a recycling plant which enables simple, flexible, qualitatively reliable and energy-efficient recycling of plastic waste material, in particular polyolefin waste material.

This object is achieved by a recycling plant for recycling plastic waste material, in particular polyolefin waste material, comprising
a first screw machine, in particular a first multi-shaft screw machine, for melting the plastic waste material to form a plastic waste material melt,
a second multi-shaft screw machine with
   a first supply opening for supplying plastic raw material and
   a second supply opening for supplying the plastic waste material melt,
      a supplying device for supplying the plastic waste material melt into the second multi-shaft screw machine.

The advantages of the recycling plant according to the disclosure correspond to the already described advantages of the method according to the disclosure for recycling plastic waste material, in particular polyolefin waste material. In particular, the recycling plant can be further embodied with at least one feature described in connection with the method according to the disclosure. Accordingly, the method according to the disclosure can be further embodied with at least one feature which is described in connection with the recycling plant according to the disclosure.

In particular, the first screw machine comprises at least one treatment element shaft. In one example, the first screw machine is designed as a multi-shaft screw machine. In particular, the first multi-shaft screw machine comprises at least two treatment element shafts which rotate in the same direction and/or are designed to intermesh tightly. In one example, the first multi-shaft screw machine is designed as a two-shaft screw machine rotating in the same direction. In particular, the first screw machine comprises an intake zone, a melting zone, a degassing zone and a discharge zone. In particular, the first screw machine comprises at least one supply opening for supplying the plastic waste material and/or for supplying plastic raw material and/or for supplying at least one additive. In one example, the first screw machine comprises a first supply opening for supplying the plastic waste material and a second supply opening for supplying the plastic raw material and/or the at least one additive. For supplying the plastic waste material, the recycling plant comprises in particular a supply screw machine which opens into the first supply opening.

In particular, the second multi-shaft screw machine comprises at least two treatment element shafts that rotate in the same direction and/or are designed to intermesh tightly. In one example, the second multi-shaft screw machine is designed as a two-shaft screw machine rotating in the same direction. In particular, the second multi-shaft screw machine comprises a first intake zone with the first supply opening, a melting zone, a second intake zone with the second supply opening, a homogenizing zone and a discharge zone.

In particular, the first screw machine can be retrofitted to an existing second multi-shaft screw machine.

A recycling plant comprising a throttling device for adjusting a dwell time of the plastic waste material melt in the first screw machine, ensures simple, flexible, qualitatively reliable and energy-efficient recycling. In particular, the throttling device is arranged downstream of the first screw machine and enables adjustment of a dwell time of the plastic waste material melt in the first screw machine. The throttling device comprises at least one throttling element for adjusting a flow resistance of the plastic waste material melt. The position of the at least one throttling element can be adjusted or changed for this purpose. A higher flow resistance leads to a longer dwell time and vice versa. By increasing the dwell time, the plastic waste material melt in the first screw machine is mixed and homogenized longer and thus more intensively, which has a positive effect on the quality of the plastic waste material melt.

A recycling plant comprising a filter device for filtering the plastic waste material melt before it is supplied into the second multi-shaft screw machine, ensures simple, flexible, qualitatively reliable and energy-efficient recycling. In particular, the filter device comprises at least two filter elements. Alternatively, the filter device comprises at least one filter element with a continuous cleaning and/or with a backwash function. This makes it possible to clean and/or replace at least one filter element during operation. The filter device is designed in particular as a screen changing device. In particular, the filter device is arranged between the first screw machine and the second multi-shaft screw machine.

A recycling plant comprising at least one sensor for determining at least one parameter of the plastic waste material melt, ensures simple, flexible, qualitatively reliable and energy-efficient recycling. The determined at least one parameter characterizes in particular a quality feature of the plastic waste material melt. Determining at least one parameter of the plastic waste material melt makes it possible, in particular, to determine a quality measure. The at least one sensor in particular has a signal connection with a control device. This allows the measured parameter values to be transmitted to the control device. The at least one sensor is, in particular, a pressure sensor for measuring a pressure of the plastic waste material melt, a temperature sensor for measuring a temperature of the plastic waste material melt and/or a viscosity sensor for measuring a viscosity of the plastic waste material melt. In particular, the at least one sensor is arranged directly downstream of the first screw machine and/or directly upstream of a filter device and/or downstream of a filter device. In one example, at least one sensor is used to measure a pressure, a temperature and/or a viscosity of the plastic waste material melt immediately downstream of the first screw machine and/or immediately upstream of the filter device and/or downstream of the filter device. The measurement immediately downstream of the first screw machine provides information regarding the flow properties of the uncleaned plastic waste material melt. The measurement immediately upstream of the filter device provides information on the pressure increase as a function of time and/or on the degree of contamination of the plastic waste material melt as a function of a filtration fineness of the filter device. The filtration fineness of the at least one filter element is selected in dependence on the required quality of the plastic material melt. The measurement downstream of the filter device, in particular the viscosity measurement or the online viscosity measurement, provides information about the flow properties of the filtered plastic waste material melt and the expected viscosity of the plastic material melt. In particular, the viscosity can be adjusted by setting the dwell time of the plastic waste material melt in the first screw machine and/or by adding plastic raw material to the first screw machine.

A recycling plant comprising a control device for determining a quality measure for the plastic waste material melt in dependence on the determined at least one parameter of the plastic waste material melt, ensures simple, flexible, qualitatively reliable and energy-efficient recycling. The control device makes it possible to determine a quality measure for assessing the quality of the plastic waste material melt. Further, the control device makes it possible to actuate at least one supplying device and/or a throttling device in dependence on the determined at least one parameter and/or in dependence on the determined quality measure.

A recycling plant in which the supplying device for supplying the plastic waste material melt comprises at least one switching element, ensures simple, flexible, qualitatively reliable and energy-efficient recycling. Due to the fact that the supplying device comprises at least one switching element, the supplying device or the at least one switching element can be switched at least between a first switching position and a second switching position. In the first switching position, the supplying device forms a first channel, which is connected to the second supply opening and opens into the second multi-shaft screw machine. The plastic waste material melt is thus supplied into the second multi-shaft screw machine in the first switching position. In the second switching position, the supplying device forms a second channel that does not open into the second multi-shaft screw machine. The second channel leads, for example, to a pelletizing device. The supplying device is designed, for example, as a diverter valve and/or valve.

A recycling plant comprising a supplying device for supplying plastic raw material and/or for supplying at least one additive into the first screw machine, ensures simple, flexible, qualitatively reliable and energy-efficient recycling. The supplying device enables the supply of plastic raw material and/or the supply of at least one additive into the first screw machine, so that the quality and/or the colour of the plastic waste material melt can be influenced. In particular, the supplying device comprises at least one dosing unit. The at least one dosing unit is, for example, designed to be volumetric and/or gravimetric. The at least one additive comprises, for example, powdered carbon black (FCB: Free Carbon Black), colour pigments, peroxide, UV stabilizers and/or antioxidants.

A recycling plant in which a control device for actuation has a signal connection with the supplying device for supplying the plastic waste material melt and/or with a supplying device for supplying plastic raw material and/or for supplying at least one additive into the first screw machine and/or with a throttling device, ensures simple, flexible, qualitatively reliable and energy-efficient recycling. The actuation takes place in particular in dependence on at least one parameter of the plastic waste material melt and/or a determined quality measure of the plastic waste material melt. Due to the fact that the control device has a signal connection with the supplying device for supplying the plastic waste material melt into the second multi-shaft screw machine, the supplying device can be actuated in such a manner that the plastic waste material melt is supplied into the second multi-shaft screw machine if the plastic waste material melt is of sufficient quality, and that the plastic waste material melt is not supplied into the second multi-shaft screw machine if the plastic waste material melt is not of sufficient quality. Due to the fact that the control device has a signal connection with the supplying device for supplying plastic raw material and/or for supplying at least one additive into the first screw machine, plastic raw material and/or at least one additive can be supplied into the first screw machine if the quality of the plastic waste material melt is insufficient, so that the quality of the plastic waste material melt is increased. Due to the fact that the control device has a signal connection with the throttling device, a dwell time of the plastic waste material melt in the first screw machine can be set. By increasing the dwell time, the plastic waste material melt in the first screw machine is mixed and homogenized longer and thus more intensively, which has a positive effect on the quality of the plastic waste material melt.

Further features, advantages and details of the disclosure are shown in the following description of an exemplary embodiment.

### BRIEF DESCRIPTION OF THE DRAWINGS

FIG. 1 shows a schematic representation of a recycling plant for recycling plastic waste material, in particular polyolefin waste material, with a first multi-shaft screw machine for melting the plastic waste material to form a plastic waste material melt and a second multi-shaft screw machine for mixing the plastic waste material melt with a plastic raw material melt,

FIG. 2 shows a side view of the first multi-shaft screw machine,

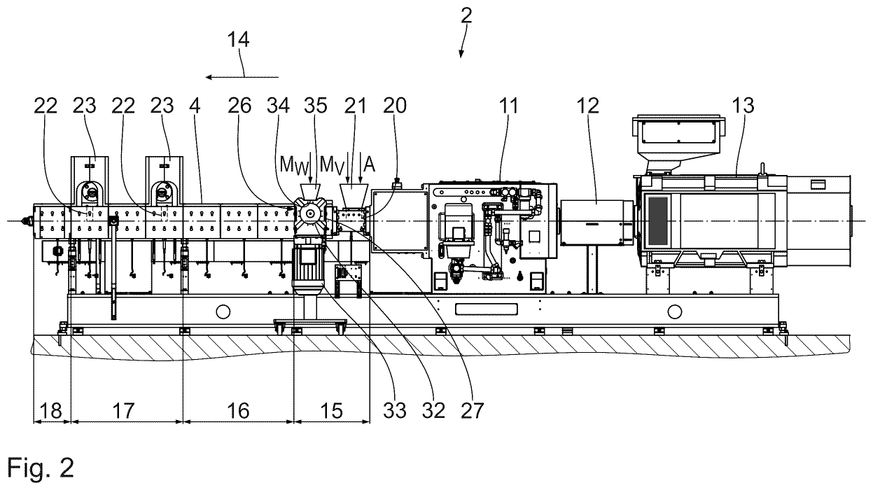

FIG. 3 shows a partially sectioned plan view of the first multi-shaft screw machine in FIG. 2,

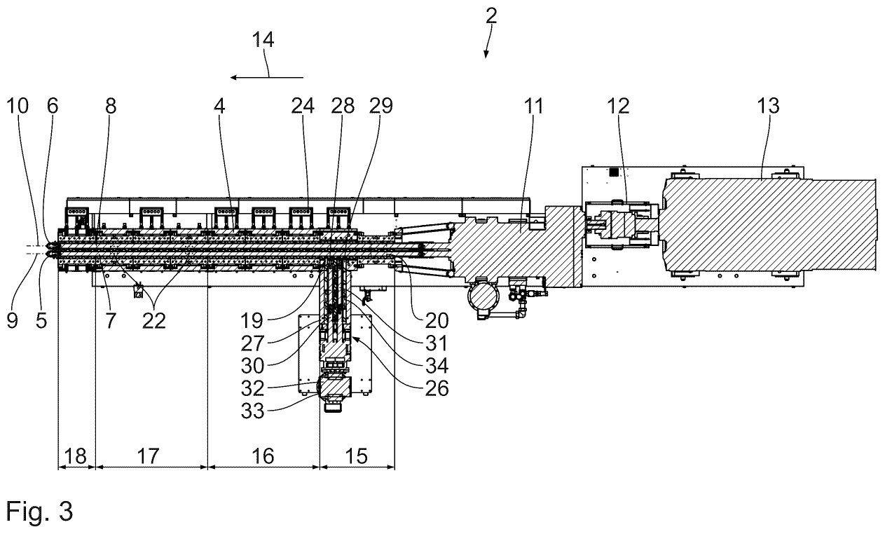

FIG. 4 shows a sectional view through a throttling device of recycling plant,

FIG. 5 shows a side view of the second multi-shaft screw machine, and

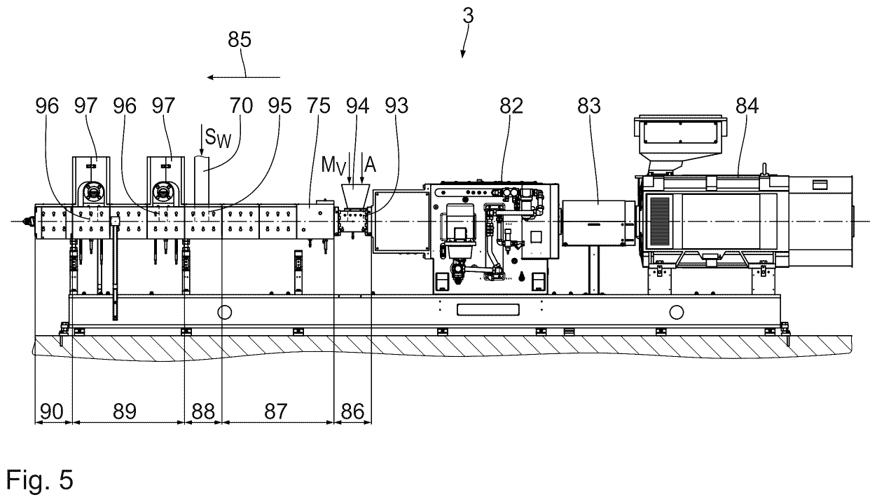

FIG. 6 shows a partially sectioned plan view of the second multi-shaft screw machine in FIG. 5.

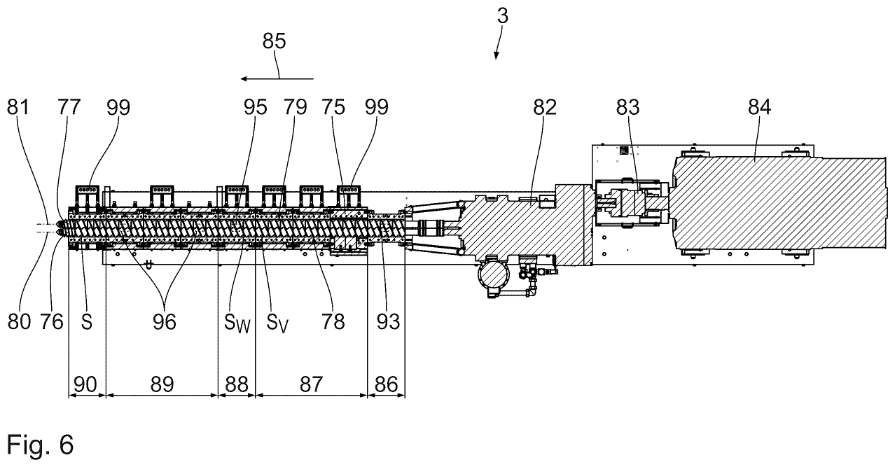

### DETAILED DESCRIPTION

A recycling plant 1 for recycling plastic waste material M_{W}, in particular polyolefin waste material, comprises a first screw machine 2 and a second multi-shaft screw machine 3. The screw machine 2 is designed as a multi-shaft screw machine. Alternatively, the screw machine 2 can also be designed as a single-shaft screw machine.

The first multi-shaft screw machine 2 serves to melt the plastic waste material M_{W} into a plastic waste material melt S_{W}, in particular into a polyolefin waste material melt. The first multi-shaft screw machine 2 is designed as a two-shaft screw machine. The first multi-shaft screw machine 2 has a housing 4, which comprises a plurality of housing portions arranged in succession and fastened to one another. Two housing bores 5, 6 are formed in the housing 4, which penetrate each other and have the shape of a horizontal figure eight in cross-section. Two tightly intermeshing treatment element shafts 7, 8 are arranged in the housing bores 5, 6 and can be driven in rotation about associated axes of rotation 9, 10. The treatment element shafts 7, 8 are driven in the same direction of rotation by a drive motor 13 via a transfer gear 11 and a coupling 12.

The first multi-shaft screw machine 2 has an intake zone 15, a melting zone 16, a degassing zone 17 and a discharge zone 18 successively in a conveying direction 14.

In the intake zone 15, a first supply opening 19 is formed laterally in the housing 4. The first supply opening 19 serves to supply the plastic waste material M_{W}. A second supply opening 20 is formed in the housing 4 in the intake zone 15 for supplying plastic raw material M_{V} and/or for supplying at least one additive A. The second supply opening 20 is formed upstream of the first supply opening 19. A funnel 21 is connected to the second supply opening 20. In the intake zone 15, the treatment element shafts 7, 8 have screw elements.

The melting zone 16 serves to melt the plastic waste material M_{W} and/or the plastic raw material M_{V} and to melt or mix in any additive A or additives A that may have been added. In the melting zone 16, the treatment element shafts 7, 8 have screw elements and/or kneading elements.

The degassing zone 17 serves to homogenize and degas the produced plastic waste material melt M_{W}. In the degassing zone 15, degassing openings 22 are formed in the housing 4, to which degassing devices 23 are connected. In the degassing zone 17, the treatment element shafts 7, 8 have screw elements and/or kneading elements.

The discharge zone 18 serves to discharge the plastic waste material melt S_{W} from the first multi-shaft screw machine 2 through a discharge opening. In the discharge zone 18, the treatment element shafts 7, 8 have screw elements.

For heating the housing 4, the first multi-shaft screw machine 2 comprises heating devices 24, which are connected to the housing 4 in the intake zone 15, the melting zone 16, the degassing zone 17 and the discharge zone 18.

The recycling plant 1 comprises a first supplying device 25, which is associated with the first multi-shaft screw machine 2. The first supplying device 25 comprises a two-shaft supply screw machine 26. The supply screw machine 26 is designed as a side-feed machine. The supply screw machine 26 is connected to the side of the housing 4 and opens into the first supply opening 19.

The supply screw machine 26 comprises a housing 27 with housing bores 28, 29, in which screw shafts 30, 31 are arranged to be driven in the same direction of rotation. The screw shafts 30, 31 are driven in the same direction, i.e. in the same direction of rotation, by a drive motor 33 around associated axes of rotation via a transfer gear 32. A feed opening 34 is formed in the housing 27, which feed opening 34 opens into the housing bores 28, 29 and to which a hopper 35 is connected. The supply screw machine 26 is used for supplying the plastic waste material M_{W}.

The first supplying device 25 further comprises a first dosing unit 36 for supplying plastic raw material M_{V} and a second dosing unit 37 for supplying at least one additive A through the second supply opening 20 into the first multi-shaft screw machine 2. The dosing units 36, 37 are designed to be gravimetric, for example.

The recycling plant 1 comprises a throttling device 38, which is arranged downstream of the first multi-shaft screw machine 2 with respect to the conveying direction 14. The throttling device 38 is attached to the housing 4. The throttling device 38 is designed as a start-up valve throttling device. A first pressure sensor 53, which measures a pressure p₁ of the plastic waste material melt S_{W} immediately downstream of the first multi-shaft screw machine 2, and a first temperature sensor 56, which measures a temperature T₁ of the plastic waste material melt S_{W} immediately downstream of the first multi-shaft screw machine 2, are arranged between the first multi-shaft screw machine 2 and the throttling device 38.

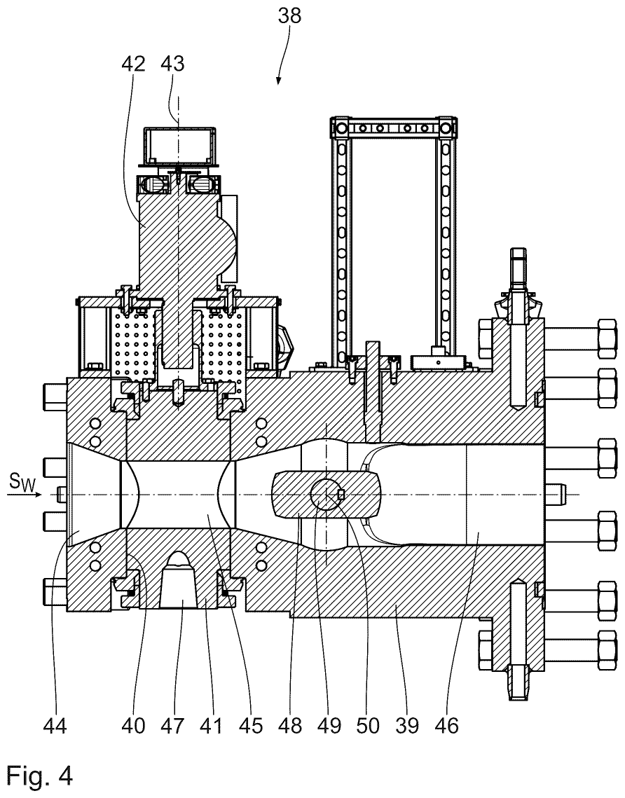

The throttling device 38 comprises a housing 39 in which a cylindrical housing recess 40 is formed. A correspondingly cylindrical switching element 41 is arranged in the housing recess 40, which can be swivelled about a swivel axis 43 in the housing recess 40 by means of a drive 42. In the housing 39, an inlet channel 44 is formed, which connects the housing bores 5, 6 with the housing recess 40. The switching element 41 forms a passage channel 45 which, in a discharge position shown in FIG. 4, connects the inlet channel 44 with a discharge channel 46. The switching element 41 further forms an ejection channel 47, which connects the inlet channel 44 to the surroundings in a discharge position. To switch between the ejection position and the discharge position, the switching element 41 can be swivelled about the swivel axis 43 by means of the drive 42.

In the discharge channel 46, a throttling element 48 is arranged, which can be swivelled about a swivel axis 50 by means of a drive 49. Only a drive shaft of the drive 49 can be seen in FIG. 4. In the discharge position, the throttling element 48 serves to set the dwell time of the plastic waste material melt S_{W} in the first multi-shaft screw machine 2. The throttling device 38 can also be designed in accordance with the start-up valve throttling devices described in EP 3 552 798 A1. The disclosure content of EP 3 552 798 A1 is incorporated by reference into this patent application.

The recycling plant 1 comprises a melt pump 51, which is arranged downstream of the throttling device 38 with respect to the conveying direction 14. The melt pump 51 is designed, for example, as a gear pump. The melt pump 51 serves to increase the pressure of the plastic waste material melt S_{W}.

Further, the recycling plant 1 comprises a filter device 52, which is arranged downstream of the melt pump 51 with respect to the conveying direction 14. The filter device 52 comprises at least two filter elements. The filter device 52 is designed, for example, as a screen changing device.

The filter device 52 comprises a second pressure sensor 53′, which measures a pressure p2 of the plastic waste material melt S_{W} upstream of the filter device 52. Further, the filter device 52 comprises a second temperature sensor 56′, which measures a temperature T₂ of the plastic waste material melt S_{W} upstream of the filter device 52.

The filter device 52 is connected to a second supplying device 55 via a pipe 54. A measuring region M is formed in the pipe 54, in which various parameters of the plastic waste material melt S_{W} are determined or measured by means of sensors 57, 58, 59. A third pressure sensor 57 is used to determine or measure a pressure p₃ of the plastic waste material melt S_{W} downstream of the filter device 52. By means of a third temperature sensor 58, the temperature T₃ of the plastic waste material melt S_{W} is determined or measured. Further, a viscosity η is determined or measured by means of a viscosity sensor 59.

The recycling plant 1 comprises a control device 60. The sensors 53, 53′, 56, 56′, 57, 58, 59 have a signal connection with the control device 60.

The second supplying device 55 comprises a housing 61 in which a housing recess 62 is formed. In the housing recess 62, a switching element 63 is arranged, which can be displaced in the housing recess 62 by means of a drive 64. An inlet channel 65 is formed in the housing 61, which is connected to the pipe 54. Further, a first discharge channel 66, an ejection channel 67 and a second discharge channel 68 are formed in the housing 61.

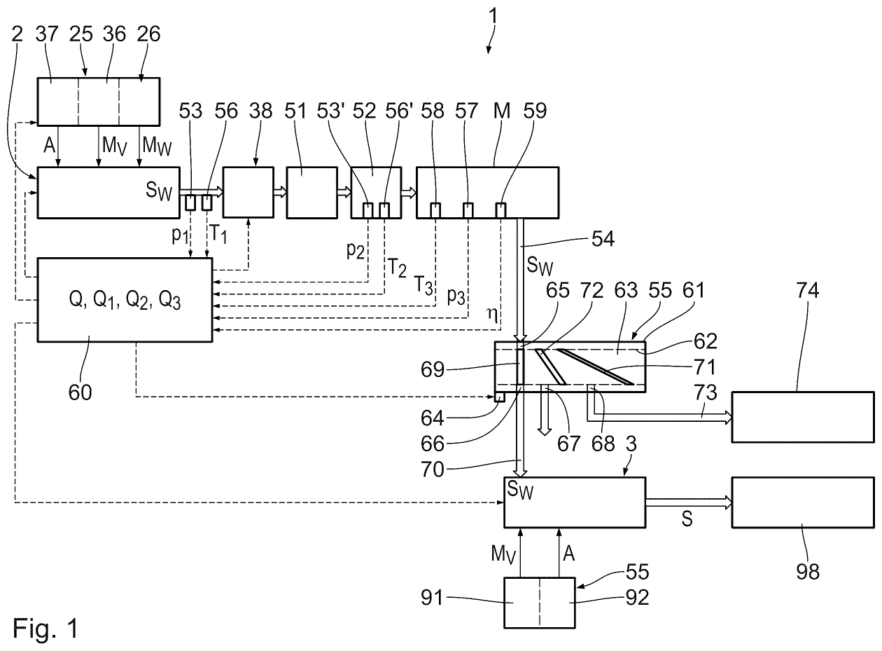

In the switching element 63, a first passage channel 69 is formed, which connects the inlet channel 65 to the first discharge channel 66 in a first switching position of the switching element 63. The first switching position is shown in FIG. 1. The first discharge channel 66 is connected to the second multi-shaft screw machine 3 via a pipe 70.

Furthermore, the switching element 63 comprises a second passage channel 71 which, in a second switching position, connects the inlet channel 65 to the second discharge channel 68. The second discharge channel 68 is connected to a first pelletizing device 74 via a pipe 73. The first pelletizing device 74 is designed, for example, as an underwater pelletizing device. The switching element 63 further comprises a third passage channel 72 which, in a third switching position, connects the inlet channel 65 to the discharge channel 67. The ejection channel 67 opens into the environment.

The second supplying device 55 further comprises a first dosing unit 91 for supplying plastic raw material M_{V} and a second dosing unit 92 for supplying at least one additive A into the second multi-shaft screw machine 3. The dosing units 91, 92 are designed to be gravimetric, for example.

The second multi-shaft screw machine 3 is designed as a two-shaft screw machine. The second multi-shaft screw machine 3 has a housing 75 which comprises a plurality of housing portions arranged in succession and fastened to one another. Two housing bores 76, 77 are formed in the housing 75, which penetrate each other and have the shape of a horizontal figure eight in cross-section. Two tightly intermeshing treatment element shafts 78, 79 are arranged in the housing bores 76, 77 and can be driven in the same direction of rotation about associated axes of rotation 80, 81. The treatment element shafts 78, 79 are driven in rotation in the same direction, i.e. in the same directions of rotation, by a drive motor 84 via a transfer gear 82 and a coupling 83.

The second multi-shaft screw machine 3 has a first intake zone 86, a melting zone 87, a second intake zone 88, a homogenizing zone 89 and a discharge zone 90 in succession in a conveying direction 85.

In the first intake zone 86, a first supply opening 93 is formed in the housing 75. A hopper 94 is connected to the first supply opening 93. The first supply opening 93 opens into the housing bores 76, 77 and serves to supply plastic raw material M_{V} and/or the at least one additive A. The dosing units 91, 92 open into the hopper 94. In the first intake zone 86, the treatment element shafts 78, 79 comprise screw elements.

The melting zone 87 serves to melt the plastic raw material M_{V} and, if necessary, the additive A or additives A. In the melting zone 87, the treatment element shafts 78, 79 comprise screw elements and/or kneading elements.

In the second intake zone 88, a second supply opening 95 is formed in the housing 75. The second supply opening 95 opens into the housing bores 76, 77. The second supply opening 95 serves to supply the plastic waste material melt S_{W}. The pipe 70 is connected to the second supply opening 95. In the second intake zone 88, the treatment element shafts 78, 79 comprise screw elements.

The homogenizing zone 89 serves to homogenize the plastic raw material melt S_{V} and the plastic waste material melt S_{W} and to degas the resulting plastic material melt S. For degassing, degassing openings 96 are formed in the housing 75, to each of which a degassing device 97 is connected. In the degassing zone 89, the treatment element shafts 78, 79 comprise screw elements and/or kneading elements.

The discharge zone 90 serves to discharge the plastic material melt S through a discharge opening of the second multi-shaft screw machine 3. In the discharge zone 90, the treatment element shafts 78, 79 comprise screw elements.

For heating the housing 75, the second multi-shaft screw machine 3 comprises heating devices 99, which are connected to the housing 75 in the melting zone 87, the second intake zone 88, the homogenizing zone 89 and the discharge zone 90.

The recycling plant 1 comprises a second pelletizing device 98 for pelletizing the plastic material melt S. The second pelletizing device 98 is arranged downstream of the second multi-shaft screw machine 3 and is connected to the discharge opening. The second pelletizing device 98 serves to produce pellets from the plastic material melt S. The second pelletizing device 98 is designed, for example, as an underwater pelletizing device.

The multi-shaft screw machines 2, 3, the supplying devices 25, 55 and the throttling device 38 have a signal connection with the control device 60 for actuation purposes.

The functional principle of the recycling plant 1 and the method for recycling the plastic waste material S_{W} are described below:

The plastic waste material M_{W} is supplied to the first multi-shaft screw machine 2 by means of the first supplying device 25. For this purpose, the plastic waste material M_{W}, which is present as bulk material, is supplied via the feed opening 34 to the supply screw machine 26, which conveys the plastic waste material M_{W} via the first supply opening 19 into the housing bores 5, 6 of the first multi-shaft screw machine 2. The plastic waste material M_{W} has been produced from plastic products that have been washed and/or shredded. The plastic waste material M_{W} is present in particular as shreds and/or pellets. The plastic waste material M_{W} is degassed and compacted in the supply screw machine 26.

If required, plastic raw material M_{V} can be supplied to the first multi-shaft screw machine 2 via the second supply opening 20 by means of the dosing unit 36 and/or at least one additive A can be supplied by means of the dosing unit 37.

In the melting zone 16, the plastic waste material M_{W} and, if necessary, the plastic raw material M_{V} or the at least one additive A are melted and mixed. The heating devices 24 are used to heat the housing 4 and support the melting process. The resulting plastic waste material melt S_{W} is homogenized and degassed in the degassing zone 17. The plastic waste material melt S_{W} is then discharged from the first multi-shaft screw machine 2 via the discharge zone 18 and the associated discharge opening. By means of the first pressure sensor 53 and the first temperature sensor 56, the pressure p₁ and the temperature T₁ of the plastic waste material melt S_{w} are monitored immediately downstream of the multi-shaft screw machine 2.

After the first multi-shaft screw machine 2 has started up, the switching element 41 of the dosing device 38 is transferred from the ejection position to the discharge position, so that the plastic waste material melt S_{W} flows from the inlet channel 44 through the passage channel 45 into the discharge channel 46. The flow resistance in the discharge channel 46 can be adjusted by means of the throttling element 48, which in turn allows the dwell time of the plastic waste material melt S_{W} in the first multi-shaft screw machine 2 to be set. With a longer dwell time of the plastic waste material melt S_{W} in the first multi-shaft screw machine 2, a longer or more intensive mixing and homogenization of the plastic waste material melt S_{W} takes place, which has a positive effect on the viscosity or quality of the plastic waste material melt S_{W}.

The plastic waste material melt S_{W} is conveyed through the filter device 52 by means of the melt pump 51 and filtered therein. The second pressure sensor 53′ is used to monitor the pressure p₂ of the plastic waste material melt S_{W} upstream of the filter element, so that the filter element can be replaced if it becomes contaminated. Further, the temperature T₂ of the plastic waste material melt S_{W} is monitored by means of the second temperature sensor 56′.

Various parameters are measured in the measuring region M using the sensors 57, 58, 59. The measured parameters include, in particular, the pressure p₃, the temperature T₃ and the viscosity η of the plastic waste material melt S_{W}. The measured parameters are supplied to the control device 60 via the signal connection.

The control device 60 determines a quality measure Q for the plastic waste material melt S_{W} in dependence on at least one parameter of the plastic waste material melt S_{W}. The quality measure Q is assigned to one of multiple quality classes Q₁, Q₂, Q₃ by means of the control device 60. Depending on the determined quality measure Q, the first supplying device 25, the throttling device 38 and/or the second supplying device 55 are actuated by the control device 60. The quality class Q₁ characterizes a high quality, the quality class Q₂ a medium quality and the quality class Q₃ a low quality of the plastic waste material melt S_{W}.

For example, the quality measure Q is the measured viscosity η of the plastic waste material melt Sw. If necessary, the measured values can be processed by the control device 60, for example by suppressing noise through signal processing. If the viscosity η is within a predefined range, the quality class Q₁ is provided. If, on the other hand, the viscosity η is outside the predefined range, the quality class Q₂ or Q₃ is provided. The quality class Q₃ is provided, for example, if the quality measure Q or the viscosity η is outside a predefined usability range of the plastic waste material melt S_{W}. The assessment of the quality of the plastic waste material melt S_{W} depends in particular on the predefined requirements for the plastic material melt S.

If the control device 60 determines a quality measure Q associated with the quality class Q₁, the control device 60 actuates the drive 64 in such a manner that the switching element 63 is moved to the first switching position. In the first switching position, the plastic waste material melt S_{W} is supplied to the second multi-shaft screw machine 3.

If the control device 60 determines a quality measure Q associated with the quality class Q₂, the throttling device 38 is actuated by the control device 60 in such a manner that the flow resistance and thus the dwell time of the plastic waste material melt S_{W} in the first multi-shaft screw machine 2 is increased. Further, by means of the control device 60, the first supplying device 25 is actuated in such a manner that the quality of the plastic waste material melt S_{W} is increased by the supply of plastic raw material M_{V} and/or at least one additive A. The drive 64 of the second supplying device 55 is actuated by the control device 60 in such a manner that the switching element 63 is moved to the second switching position. In the second switching position, the plastic waste material melt S_{W} is supplied via the pipe 73 to the pelletizing device 74, which produces a low-quality pellet from the plastic waste material melt S_{W}, which can, however, still be processed further.

If the control device 60 determines a quality measure Q associated with the quality class Q₃, the throttling device 38 and the first supplying device 25 are actuated in such a manner that the quality of the plastic waste material melt S_{W} is increased. This actuation has already been described in connection with the quality class Q₂. Further, the drive 64 of the second supplying device 55 is actuated by the control device 60 in such a manner that the switching element 63 is moved to the third switching position. In the third switching position, the plastic waste material melt S_{W} is discharged into the environment and disposed of, since further processing is not possible.

Parallel to the production of the plastic waste material melt S_{W} by means of the first multi-shaft screw machine 2, a plastic raw material melt S_{V} is produced by means of the second multi-shaft screw machine 3. Plastic raw material M_{V} and, if necessary, at least one additive A are supplied to the second multi-shaft screw machine 3 by means of the dosing units 91, 92 via the first supply opening 93. The plastic raw material M_{V} is supplied in particular as bulk material, in particular as powder and/or pellets. The plastic raw material M_{V} and the at least one additive A are melted and mixed in the melting zone 87 to form a plastic raw material melt S_{V}.

Alternatively, a plastic raw material melt S_{V} can already be supplied via the first supply opening 93.

In the second intake zone 88, the plastic raw material melt S_{V} is supplied with the plastic waste material melt S_{W} via the pipe 70 and the second supply opening 95. In the homogenizing zone 89, the plastic raw material melt S_{V} and the plastic waste material melt S_{W} are mixed together and homogenized and degassed via the degassing openings 96 by means of the degassing devices 97. The housing 75 is heated by means of the heating devices 99. The resulting plastic material melt S is discharged in the discharge zone 90 via the discharge opening and supplied to the pelletizing device 98. The pelletizing device 98 produces high-quality pellets from the plastic material melt S, which can be further processed.

The plastic waste material M_{W} has a proportion m_{W} of the plastic material melt S, wherein the following applies:
5 wt. %≤m_{W}≤50 wt. %, in particular 10 wt. %≤m_{W}≤45 wt. %, in particular 15 wt. %≤m_{W}≤40 wt. %, and in particular 20 wt. %≤m_{W}≤35 wt. %.

Due to the fact that a plastic waste material melt S_{W} is supplied to the second multi-shaft screw machine 3, the recycling of plastic waste material M_{W} is simple and energy-efficient. By measuring and assessing the quality of the plastic waste material melt S_{W} and controlling the recycling plant 1 in dependence on the determined quality, flexible and qualitatively reliable recycling of plastic waste material M_{W} is also ensured. The quality measurement and/or the quality assessment are carried out online, i.e. during operation of the recycling plant 1. The first screw machine 2 can also be retrofitted. The quality measurement and quality assessment do not increase the load on an existing second multi-shaft screw machine 3 due to the plastic waste material melt S_{W}. Colourant can be supplied into the second multi-shaft screw machine 3 via the first screw machine 2, for example, so that the second multi-shaft screw machine 3 is hardly contaminated by the colourant.

In particular, the recycling plant 1 has a throughput of plastic material melt S of at least 10 t/h, in particular of at least 20 t/h and of at most 150 t/h, of which at least 5%, in particular at least 10%, is a recycled proportion.

1. A method for recycling plastic waste material, comprising the following steps:
providing a first screw machine and a second multi-shaft screw machine, p1 supplying plastic waste material into the first screw machine and melting of the plastic waste material by means of the first screw machine to form a plastic waste material melt,
supplying plastic raw material into the second multi-shaft screw machine and processing of the plastic raw material by means of the second multi-shaft screw machine to form a plastic raw material melt,
supplying the plastic waste material melt into the second multi-shaft screw machine, and
mixing the plastic raw material melt and the plastic waste material melt by means of the second multi-shaft screw machine to form a plastic material melt.

2. A method according to claim 1,
wherein the plastic waste material melt is filtered by means of a filter device before being supplied into the second multi-shaft screw machine.

3. A method according to claim 1, wherein
at least one parameter of the plastic waste material melt is determined by means of at least one sensor.

4. A method according to claim 3,
wherein a quality measure for the plastic waste material melt is determined by means of a control device in dependence on the determined at least one parameter of the plastic waste material melt.

5. A method according to claim 3, wherein at least one of
at least one supplying device and a throttling device is actuated in dependence on at least one of the at least one parameter and a determined quality measure.

6. A method according to claim 3, wherein
in dependence on at least one of the at least one parameter and a determined quality measure, a supplying device for supplying the plastic waste material melt is actuated in such a manner that
the plastic waste material melt is supplied to the second multi-shaft screw machine if at least one of the at least one parameter and the determined quality measure is within a predefined range, and
the plastic waste material melt is not supplied to the second multi-shaft screw machine if at least one of the at least one parameter and the determined quality measure (Q) is outside the predefined range (Q₁).

7. A method according to claim 3, wherein
in dependence on at least one of the at least one parameter and a determined quality measure, a supplying device for at least one of supplying plastic raw material and for supplying at least one additive is actuated in such a manner that at least one of plastic raw material and at least one additive is supplied to the first screw machine if at least one of the at least one parameter and the determined quality measure is outside a predefined range.

8. A method according to claim 1, wherein
the plastic waste material has a proportion m_{W} of the plastic material melt(S), wherein: 5 wt. %≤m_{W}≤50 wt. %,

9. A recycling plant for recycling plastic waste material, comprising
a first screw machine for melting the plastic waste material to form a plastic waste material melt,
a second multi-shaft screw machine with
a first supply opening for supplying plastic raw material and
a second supply opening for supplying the plastic waste material melt,
a supplying device for supplying the plastic waste material melt into the second multi-shaft screw machine.

10. A recycling plant according to claim 9, comprising
a throttling device for adjusting a dwell time of the plastic waste material melt in the first screw machine.

11. A recycling plant according to claim 9, comprising
a filter device for filtering the plastic waste material melt before it is supplied into the second multi-shaft screw machine.

12. A recycling plant according to claim 9, comprising
at least one sensor for determining at least one parameter of the plastic waste material melt.

13. A recycling plant according to claim 12, comprising
a control device for determining a quality measure for the plastic waste material melt in dependence on the determined at least one parameter of the plastic waste material melt.

14. A recycling plant according to claim 9, wherein
the supplying device for supplying the plastic waste material melt comprises at least one switching element.

15. A recycling plant according to claim 9, comprising
a supplying device for at least one of supplying plastic raw material and for supplying at least one additive into the first screw machine.

16. A recycling plant according to claim 11, wherein
a control device for actuation has a signal connection with at least one of the supplying device for supplying the plastic waste material melt and with a supplying device for at least one of supplying plastic raw and for supplying at least one additive into the first screw machine and with a throttling device.

17. A method according to claim 1, wherein the recycling plastic waste material is polyolefin waste material.

18. A method according to claim 1, wherein the first screw machine is a first multi-shaft screw machine.

19. A recycling plant according to claim 11, wherein the plastic waste material is a polyolefin waste material.

20. A recycling plant according to claim 11, wherein the first screw machine is a first multi-shaft screw machine.
